(19) United States
(12) Patent Application Publication
(10) Pub. No.: US 2013/0302492 A1
(43) Pub. Date: Nov. 14, 2013

(54) Process for the Production of Cheese Milk (II)

(71) Applicant: DMK DEUTSCHES MILCHKONTOR GMBH, Bremen (DE)

(72) Inventor: Sven-Rainer Doring, Zeven (DE)

(73) Assignee: DMK Deutsches Milchkontor GmbH, Bremen (DE)

(21) Appl. No.: 13/891,611

(22) Filed: May 10, 2013

(30) Foreign Application Priority Data
May 11, 2012 (EP) 12 167628.2

(51) Int. Cl. A23C 9/142

(52) U.S. Cl. CPC A23C 9/142
USPC 426/491

(57) ABSTRACT

A process for the production of cheese milk is suggested, wherein
(a) solids are removed from raw milk in a cold condition,
(b) the resulting intermediate is skimmed,
(c) the skimmed milk such obtained is subjected to microfiltration at a temperature in the range of from 5 to 25° C.,
(d) the resulting permeate is adjusted to yield the desired fat. content by adding an amount of cream that was separated in step (b), and the standardized milk such obtained is, and
(e) pasteurized in a final step.

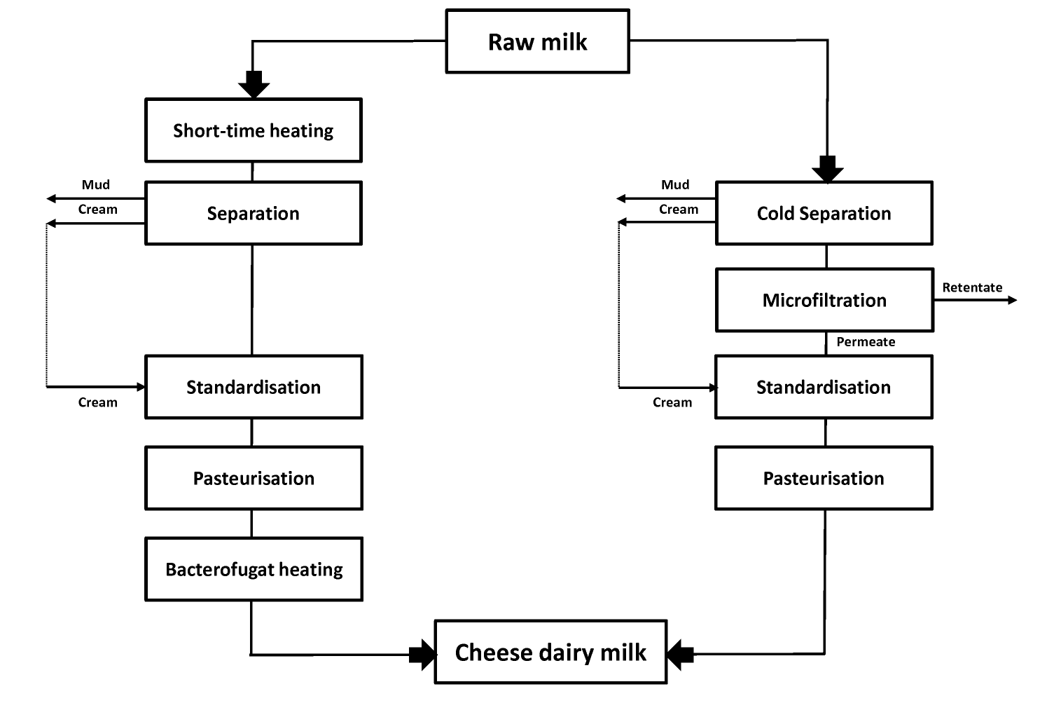

### AREA OF THE INVENTION

The invention relates to the area of food technology and specifically relates to an improved process for the production of so-called cheese milk.

### STATE OF THE ART

What Is referred to as cheese milk is raw milk, which, after pasteurization and fat adjustment, is coagulated in order to produce cheese, but also yogurt. As, in former times, cheese was mostly produced in cheese vats—which, nowadays, is partly still typical for the production of Parmesan cheese—cheese milk is synonymously referred to as milk in the vat.

In order to be used for the production of cheese, raw milk needs to conform to legal requirements which are laid down in the Cheese Ordinance. Usually, the production process begins by heating the raw milk by heat exchange using heat carrier media under a simultaneous partial heat recovery. After heating the raw milk to about 55° C., a separation into skimmed milk, cream and separator slime is performed. In doing so, heating is increased so far that a first thermization or pasteurization occurs. After subsequent standardization, the standardized milk is stored in a storage tank, and stored milk drawn from the storage tank is subjected to a second heating process of about 15 seconds at a temperature of 58° C.

This involves a significant disadvantage, which is that said pasteurization, which usually is carried out in a range of temperature of from 72 to 74° C. over a period of 15-30 seconds, only kills the vegetative bacteria present in the raw milk but not the thermo-resistant spores and thermoduric bacteria having a growth optimum at above 45° C. During heat recovery following pasteurization, the milk passes a range of temperature of about 45° C., which exactly corresponds to the growth optimum of said remaining bacteria such that the spores remaining in the pre-treated milk vigorously reciprocate.

These bacteria may cause unusual fermentations and cheese defects during cheese maturing, for example, irregular holes. In addition, the whey drained during the production of cheese will contain a correspondingly high percentage of the thermo-resistant bacteria. As in whey-processing methods heating temperatures are used which are not sufficiently high enough, the thermo-resistant bacteria contained therein are undesired and may lead to a violation of specifications in the end products, particularly with respect to the number of bacteria.

For this reason, milk such pre-treated is usually subjected to a second thermal step (thermization) and is then passed through a bactofuge to reduce the number of bacteria as far as is necessary to comply with production and legal requirements. It is obvious that the double thermal treatment is technologically complex and energy-intensive, which burdens the economy of the whole process.

Processes are known from the state of the art, which intend to eliminate the disadvantages mentioned. For example, EP 2368437 A1 (Müller) proposes to carry out the separation process in a cold condition of the raw milk and to carry out heating only with standardized milk. Even though this process has energetic advantages, degermination is unsatisfactory.

US 2002 012732 A1 (Lindquist) discloses s process in which skimmed milk is subjected to filtration obtaining a permeate and a retentate. While the permeate undergoes a heat treatment, the retentate is filtered a second time. The second permeate such obtained is added to the first permeate. The process, however, proves to be far too complex in practice.

Subject matter of U.S. Pat. No. 6,372,276 B1 (Lindquist) is a process for the production of a sterile milk by-firstly filtering raw milk and then thermally treating the permeate such obtained in a plurality of steps. However, in this process one often observes a plugging of the membranes, which leads to frequent interruptions of the continuous process and, in addition, bacteria numbers are not sufficiently reduced.

The object of the present invention was therefore to provide a standardized cheese milk or milk in the cheese vat, wherein all vegetative bacteria and all thermo-resistant spores are removed using a single thermal treatment step such that the remaining number of bacteria is below the legally permitted value and is acceptable from a production point of view.

### DESCRIPTION OF THE INVENTION

Subject-matter of the invention is a process for the production of cheese milk, wherein
(a) solids are removed from raw milk in a cold condition,
(b) the resulting intermediate is skimmed,
(c) the skimmed milk such obtained is subjected to microfiltration at a temperature in the range of from 5 to 25° C.,
(d) the resulting permeate is adjusted to yield the desired fat content by adding an amount of cream that was separated in step (b), and the standardized milk such obtained is, and
(e) pasteurized in a final step.

Surprisingly it was found that a combination of cold milk separation and a downstream microfiltration step in sum results in a lower number of remaining bacteria and solves the problem of membrane clogging. In doing so, it has proved to be unnecessary to use membranes with pore diameters of below 0.5 μm. For a practical quantitative separation of the microorganisms, which have proved to be resistant against thermal treatment, a pore size of from 1.1 to 2 μm is completely sufficient, particularly when ceramic is used as membrane material. In doing so, the problem of clogging is simultaneously solved and a continuous mode of operation is ensured.

In addition, the process according to the invention has the advantage that the heating of raw milk is performed only once, directly before passing the cheese milk into the cheese vat, thus effecting the legally required pasteurization. Standardized milk such obtained does not need to be treated in a bactofuge.

### Cold Milk Separation

In an advantageous embodiment of the process according to the invention it is provided that the temperature of the cold condition of the raw milk is adjusted to an optimum value for separation by heat exchange using a heat carrier medium. Usually, raw milk is available in a cooled condition; however, this temperature does not correspond to the value which is most effective for performing cold separation and most gentle with respect to the milk fat (cream). It is, therefore, adjusted to the optimum value for its separation by heat exchange. The resulting cold exchange may be made available to other processes conducted in a dairy, particularly by a so-called heat exchanger. For example, the temperature of the cooled raw milk does not exceed 6° C. while the optimum temperature for cold separation is in the range of from 8 to 12° C. In this case, heat exchange is performed by heating the raw milk such that the temperature of its cold condition is increased to a value within this range. In dairies there is usually excess heat. Therefore, low-temperature water obtained in dairy processes may be used as a heat carrier medium for heating. Said Sow-temperature water is fed to the heat exchange process at a temperature, which is, for example, in the range of 35° C., and is then cooled down to a temperature, which is, for example, in the range of from 11 to 15° C. by heat exchange. In doing so, the process according to the invention provides an important cold source for dairy processes.

The separation of solids (“cheese fines”) and the skimming of a fat content of about 4% by weight is usually carried out in a downstream component, preferably, a separator. Said components are adequately known from the state of the art. Separators of the company GEA Westfalia Separator GmbH, which allow the joint or single use of both steps (http://www.westfalia-separator.com/de/anwendungen/molkereitechnik/milch-molke.html) are widely used in milk industry. Preferred cold milk separators are offered by this company under the name “Procool”. Corresponding components have been disclosed, for example, in DE 10026085 C1 (Westfalia) and DE 1031526 B3 (Westfalia), and are perfectly known to one skilled in the art. Thus no explanations are needed on carrying out these process steps, as they are understood to be part of the general specialist knowledge.

### Microfiltration

Microfiltration is a process for substance removal. The essential difference between microfiltration and ultrafiltration lies in the different pore sizes and the different membrane structure as well as in the materials and filter materials involved. A filtration through membranes having a pore size <0.1 μm is usually referred to as ultrafiltration, while a filtration using pore sizes >0.1 μm is usually referred to as microfiltration. In both cases purely physical, i.e. mechanical membrane separation methods, which apply the principle of mechanical size exclusion, are concerned: all particles in the fluids, which are larger than the membrane pores, are held back by the membrane. The driving force in both separation methods is the differential pressure between the inlet and the outlet of the filter area, which is between 0.1 and 10 bar. The filter area material may consist of—depending on the area of application —stainless steel, synthetic material, ceramic or textile fabric. Filter elements appear in different forms: candle filters, flat membranes, spiral coil membranes, bag filters and hollow fibre modules; all of them are principally suitable within the meaning of the present invention.

In milk technology there has been a prejudice according to which pore diameters should not fall below a value of 0.5 μm to separate microorganisms in raw milk. However, this invention includes the insight that a diameter in the range of from 1.1 to even 2 μm and, preferably, 1.3 to 1.5 μm is completely sufficient for the production of Grade “A” raw milk if the majority of thermo-labile bacteria has been separated before by a corresponding thermic treatment and subsequently discharged together with the separator slime. The combination of this comparably larger pore diameter with a microfiltration device, which essentially comprises a ceramic membrane, solves the problem of frequent clogging at the same time.

### Standardization

The cream which is to be added to the skimmed milk separated from the raw milk for standardization purposes may be taken from the cream that has been separated from it before. In addition, or as an alternative, the cream which is to be added may also be taken from other processes in which whey cream is received, particularly from dairy processing. Further, by means of adding a certain amount of protein, which, for example, may be taken from another dairy process, also the protein content may be standardized during standardization.

A significant further development of the process according to the invention is that a bacteria concentrate is separated from the standardized milk. In doing so, the portion of bacteria which is prejudicial as to the quality of the cheese milk is further reduced.

Within the limits of the invention if is further provided that the standardized milk is stored before it is pasteurized. By means of storing in a milk storage tank it is possible to generate, if necessary, a residence time, if the cheese to be produced requires so. Pasteurization itself is preferably carried out in (plate) heat exchangers having a temperature gradient, which is selected such that the standardized milk is heated of from about 70 to 80° C. and, particularly, about 72 to 74° C. for a residence time of a minimum of 20 and a maximum of 60 seconds, preferably, about 30 seconds.

The particular advantage of the process is, as described, that any further thermal treatment and removal of bacteria in a bactofuge are no longer necessary. As, from an energetic perspective, microfiltration can be carried out much more efficiently than removal using a bactofuge, the economic advantage of the process according to the invention is obvious.

### Process Description

The invention is explained in more detail by the sole FIGURE below, which reflects the process as a flow chart.

The left-hand side branch of the chart describes the conventional production of cheese milk. During this process, raw milk is firstly subjected to short-time heating and then, when it is in a heated condition, it is separated from slime in a separator. Skimming is performed at the same time. The skimmed milk obtained is now adjusted to a defined fat content using a certain amount of cream (“standardized”) and subsequently pasteurized, i.e., it is heated up to a temperature of from 72 to 74° C. for about 30 seconds. To separate the spores formed during the two heating steps, further mechanical separation is then carried out in a bactofuge. The bacteria concentrate is removed and the pasteurized milk is placed, for example, into a cheese vat for further processing.

The branch in the right-hand side of the figure describes the process according to the invention. The raw milk, as above, is subjected—without further heating—to a cold separation at about 10° C., during which cream and slime are separated. Separation is followed by microfiltration, during which not only vegetative bacteria, but also spores are retained in the retentate while the permeate undergoes further processing. Part of the cream is then added back to the permeate to adjust a defined fat content. This is followed by pasteurization; further processing in a bactofuge, however, is no longer necessary, i.e. the standardized cheese milk may be passed directly into the cheese vat.

1. A process for the production of cheese milk, comprising the steps of
(a) removing solids from raw milk in a cold condition,
(b) skimming the resulting intermediate,
(c) subjecting the thus-obtained skimmed milk to microfiltration at a temperature in the range of from 5 to 25° C.,
(d) adjusting the resulting permeate to yield the desired fat content by adding an amount of cream that was separated in step (b), and
(e) pasteurizing the thus-obtained standardized milk in a final step.

2. The process of claim 1, wherein heating of the raw milk is performed only once, directly before passing the cheese milk into the cheese vat, thus effecting the legally required pasteurization.

3. The process of claim 1, wherein standardized milk such obtained is not subjected to treatment in a bactofuge.

4. The process of claim 1, wherein the solids are separated in a separator.

5. The process of claim 1, wherein the separator is operated at a temperature in the range of from 8 to 12° C.

6. The process of claim 1, wherein microfiltration is carried out by a membrane having a pore diameter of from 1.1 to 2 μm.

7. The process of claim 1, wherein microfiltration is carried out by a membrane having a pore diameter of from 1.3 to 1.5 μm.

8. The process of claim 1, wherein the membrane is a ceramic membrane.

9. A The process of claim 1, wherein during standardization the added cream is taken from the separated cream.

10. The process of claim 1, wherein during standardization the added cream is taken from whey cream received in a whey process.

11. The process of claim 1, wherein during standardization a metered quantity of protein obtained in a dairy process is added.

12. The process of claim 1, wherein a bacteria concentrate is separated from the pasteurized standardized milk.

13. The process of according to claim 1, Wherein separation is performed by centrifugation.

14. The process of claim 1, wherein the standardized milk is stored before it is pasteurized.

15. The process of claim 1, wherein the standardized milk is pasteurized at temperatures within the range of from 70 to 80° C. and for a period of from 20 to 80 seconds.
